(19) United States
(12) Patent Application Publication
(10) Pub. No.: US 2006/0143031 A1
(43) Pub. Date: Jun. 29, 2006

(54) Method and system for dynamic creation of web services

(75) Inventors: Akram A. Bou-Ghannam, Lake Worth, FL (US); Thomas E. Creamer, Boca Raton, FL (US); Neil A. Katz, Parkland, FL (US); Victor S. Moore, Lake City, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/023,842

(22) Filed: Dec. 28, 2004

(51) Int. Cl. G06Q 99/00

(52) U.S. Cl. 705/1

(57) ABSTRACT

A method (50) of dynamic creation of web services includes exposing (51) a flow of a service being built to other service providers in a network, soliciting (52) for services needed by a flow node of the flow, and enabling (55) other service providers to fill-in the services needed for the flow node. The method can further include incorporating (56) the services filled-in by the other service providers and optionally removing (57) any solicitation for services needed by the flow node once the services are filled-in and incorporated by the flow. The method can then complete (58) all the nodes of the flow, and create and deploy the service. Note, the step of soliciting can include advertising (53) WSDL files for the services needed by the flow node. The step of soliciting can also optionally include publishing (54) needed WSDL files in a UDDI-like directory.

### BACKGROUND OF THE INVENTION

1. Technical Field

This invention relates to the field of developing service oriented architecture applications, and more particularly to a method and system for dynamically creating web services.

2. Description of the Related Art

Service Oriented Architecture (SOA) allows a software programmer to model programming solutions in terms of services offered by components to anyone and to anywhere over a network. Services development tools (such as WebSphere Studio Application Developer (WSAD)) are based on the service and process (flow) programming model. The service is the key element in the architecture that binds everything together. The service is implemented by an end-point (a business application), and is described by a Web Services Definition Language (WSDL) file. The process implements a new business service, and makes use of existing services in its implementation. The process implementation can also include other processes.

The process for developing SOA applications usually involves the following steps:

1. Create the services desired for use. Turn existing assets into services, (make them reusable), or create new services from scratch.

2. Create a business process. A business process is a way of bringing all the separately built services together. A process makes a new service out of a collection of services. A build-time tool like the process editor in WSAD-IE can be used to build the business process.

3. Create the services that a service provider would want to offer. Now that a process is created in which all of the previous services had been combined into another service, the service needs to be deployed, or packaged into a file that can be put onto an application server.

With the current art, all of the steps listed above are done at build-time using build-time tools like WSAD. Existing tools fail to enable the dynamic and real-time development of new web services. A business application system that implements a service in a flow might not be known at build-time and existing tools fail to allow the tool to select and bind to business application systems in real-time and fail to fill the gaps in flow nodes where binding to an end-point is not yet completed.

### SUMMARY OF THE INVENTION

Embodiments in accordance with the invention can enable a method and system for development of new services dynamically in real-time. In one scenario, a process service that describes and implements a flow can be started, but the flow may not necessarily be complete and can be missing the service implementations for some of its nodes. As mentioned earlier a business service is implemented and executed by an endpoint, which is a business application system. The business application system that implements the service in the flow might not be known at build-time, and hence the build tool can be enhanced with the framework and method of allowing the tool to select and bind to business application systems in real-time. Accordingly, embodiments herein involve a method and framework for completing the flow and creating the service dynamically. For example, filling the gaps in the flow nodes where binding to an end-point is not yet completed enables completion of the flow.

In a first aspect of the invention, a method of dynamic creation of web services can include the steps of exposing a flow of a service being built to other service providers in a network, soliciting for services needed by a node of the flow, and enabling other service providers to fill-in the services needed for the flow node. The method can further include the steps of incorporating the services filled-in by the other service providers that were needed by the flow node and optionally removing any solicitation for services needed by the flow node once the services are filled-in and incorporated by the flow. The method can then complete all the nodes of the flow, and create and deploy the service. Note, the step of soliciting can include advertising WSDL files for the services needed by the flow node of the flow where the WSDL file represents at least one desired service that the flow needs in order to complete the service. The step of soliciting can also include publishing needed WSDL files in a Universal Description, Discovery, and Integration (UDDI)-like directory.

In a second aspect of the invention, a system for dynamically creating a web service using a network of service providers can include a processor coupled to the network of service providers. The processor can be programmed to expose a flow of a service being built to other service providers in the network, solicit for services needed by a flow node of the flow, and enable other service providers to fill-in the services needed for the flow node. The processor can be further programmed to incorporate the services filled-in by the other service providers that were needed by the flow node and optionally remove any solicitation for services needed by the flow node once the services are filled-in and incorporated by the flow. The processor can be further programmed to complete all nodes of the flow, create the service and deploy the service. The processor can solicit by advertising WSDL files for the services needed by the flow node of the flow where the WSDL file represents at least one desired service that the flow needs in order to complete the service. The processor can also solicit by publishing needed WSDL files in a Universal Description, Discovery, and Integration (UDDI)-like directory.

In a third aspect of the invention, a computer program has a plurality of code sections executable by a machine for causing the machine to perform certain steps as described in the method and systems outlined in the first and second aspects above.

### BRIEF DESCRIPTION OF THE DRAWINGS

There are shown in the drawings various embodiments, it being understood, however, that the invention is not limited to the precise arrangements and instrumentalities shown.

FIG. 1 is a diagram that illustrates a service and process programming model in accordance with an embodiment of the present invention.

FIG. 2 is a flow chart illustrating a method for dynamically creating a web service in accordance with an embodiment of the present invention.

FIG. 3 is another flow chart illustrating the method for dynamically creating a web service in accordance with an embodiment of the present invention.

### DETAILED DESCRIPTION OF THE INVENTION

Embodiments in accordance with the invention can expose the flow of a service being built to other service providers, and allow the service providers to fill-in the needed nodes in the flow. Exposure and filling-in can be accomplished by soliciting or advertising WSDL files for the services needed by the flow nodes. Typically, a WSDL file for a service describes what function the service can perform (the abstract interface), how to interact with the service (the binding), and where the service implementation is located (location). However, the WSDL files being advertised in accordance with the present invention represent what the flow (or service being created) needs in order for the service to become complete rather than what the service currently can provide. Soliciting for what is needed as opposed to what can be offered is in contrast to existing uses of WSDL files. WSDL files herein are used in an entirely different way than any other application. Again, a WSDL file as used herein does not describe a service being offered, but rather a service that is desired. These needed WSDL files can also be published into a UDDI-like directory. In this regard UDDI is being used in a different way as well. A typical UDDI is used by service requesters (consumers) to find services they want to use. In contrast, a UDDI-like directory is used herein to advertise what is desired and to solicit the help of service providers to provide the services desired. Service providers have access to the directory and can provide the needed WSDL back to the framework. If the framework accepts the WSDL from the service provider, it will incorporate the WSDL in the flow under construction, and remove the advertisement from the directory. When all nodes of the flow are completed, the framework creates the service and deploys it.

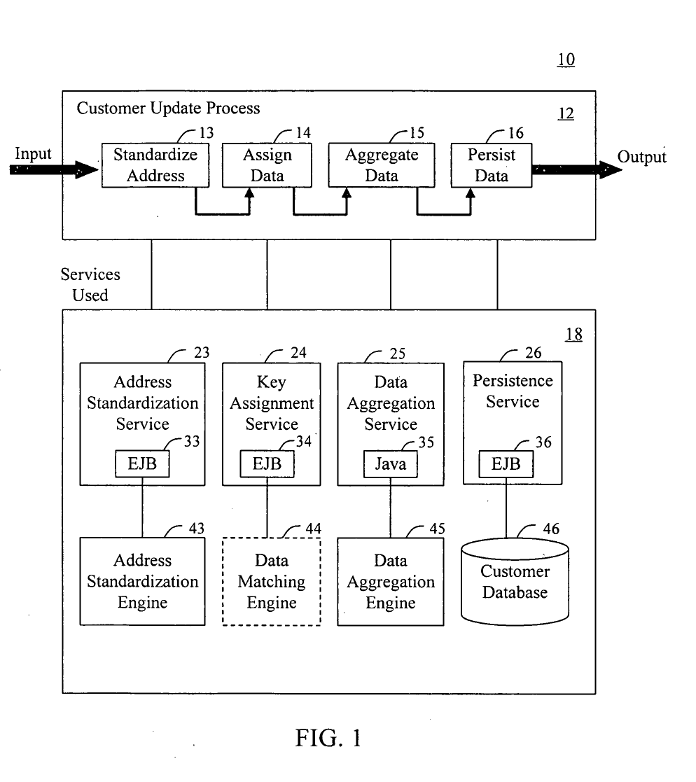

In an example scenario in reference to FIG. 1, a flow diagram illustrates a system 10 where a service is being built allowing various sources to update a customer information database 46 for an enterprise. A requirement can be that customer data from the various sources must be persisted in the enterprise customer database in a uniform manner as illustrated in the customer update process flow 12. To ensure data quality, validity, and integrity, the data must be standardized, matched, and aggregated before updating the customer data store. The process flow 12 depicting the activities of standardizing an address 13, assigning or matching 14, aggregating 15 and updating 16 is shown in FIG. 1. Each activity in the process flow invokes a respective service (23, 24, 25, or 26) among services used 18, and the service is implemented by an endpoint application respectively such as services 43, 44, 45, or 46. For example, the Standardize Address activity 13 invokes an Address Standardization Service 23, and the address standardization function is implemented by an Address Standardization Engine 43.

The illustration of FIG. 1 shows individual services developed (Address Standardization Service, Key Assignment Service, Data Aggregation Service, and Persistence Service) and being combined together into a process service (Customer Update Service) and implementing a process (the Customer Update Process). Each of the individual services is described by its own WSDL file (for example the Address Standardization Service WSDL file), and is implemented by an endpoint application (example, the Address Standardization Engine). Some of these endpoint applications might be provided by third parties, and might not be available at build-time. At build-time, the service interface (WSDL) is defined and without any particular binding to an endpoint. The individual WSDLs can be advertised as described above. Third party providers can examine the WSDL and determine if they can meet the specifications. Then, third party providers can dynamically offer their WSDL (binding to their endpoint).

In the example scenario of FIG. 1, an assumption that when building this service all the components shown in FIG. 1 is available except for the Data Matching Engine 44 can further demonstrate an embodiment of the invention. Thus, in this implementation, the Key Assignment Service 24 would not be complete since it lacks the Matching Engine endpoint (44) needed for service implementation and execution. Knowledge of multiple vendors having data matching engines enables the use of the system or framework 10 to dynamically select a vendor and build the desired service in real-time. In this regard, a special WSDL file noted above can be created for the Key Assignment Service that is only missing the service location information in the implementation part of the WSDL.

To review, a WSDL file consists of three parts: the abstract service interface, the service interface implementation, and the service location. The service interface in WSDL is called a “portType”. PortTypes consist of one or more operations with input and output. The input and output are described by messages. Service messages are typed using an XML schema. The service interface implementation is described by service provider-specific extensibility elements. The service interface implementation supports the multiple service provider-specific bindings including SOAP, Java, stateless session EJB, J2EE Connector, JMS, Process, and Transform. As shown, services 23, 24, and 26 use stateless session EJB bindings 33, 34, and 36 respectively, while service 25 uses a Java binding 35. The service location is described by a service provider-specific port extensibility element.

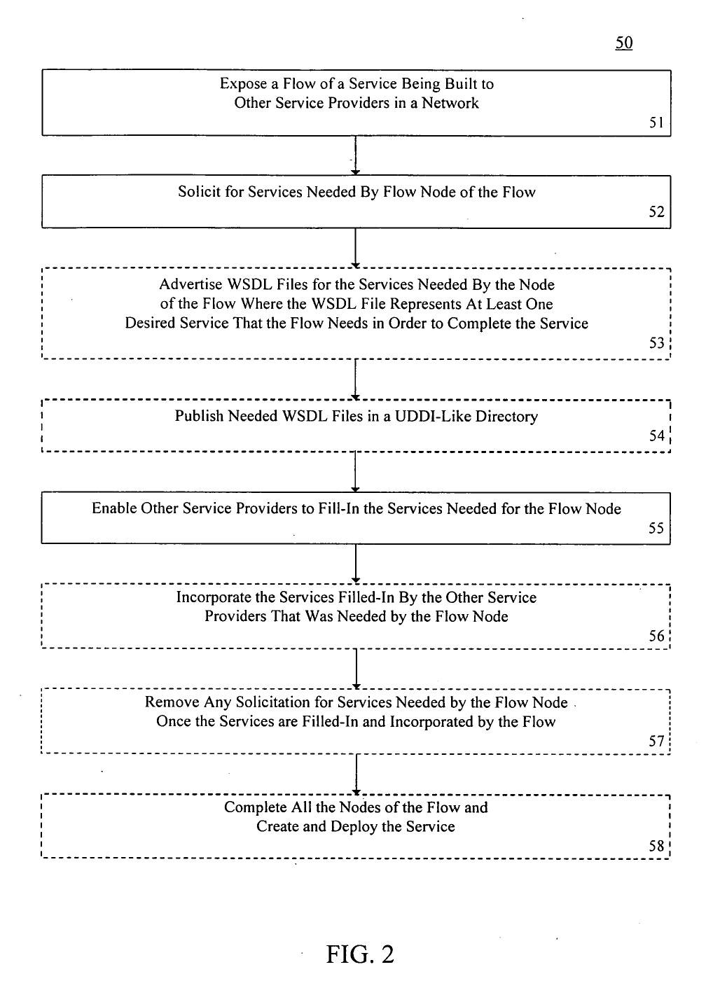

Referring now to FIG. 2, a flow chart illustrates a method 50 of dynamically building web services. The method 50 can include the step 51 of exposing a flow of a service being built to other service providers in a network, the step 52 of soliciting for services needed by a flow node of the flow, and the step 55 of enabling other service providers to fill-in the services needed for the flow node. Note, the step of soliciting can include the optional step 53 of advertising WSDL files for the services needed by the flow node of the flow where the WSDL file represents at least one desired service that the flow needs in order to complete the service. The step of soliciting can also include publishing needed WSDL files in a Universal Description, Discovery, and Integration (UDDI)-like directory at step 54. The method can further include the optional steps of incorporating the services filled-in by the other service providers that were needed by the flow node at step 56 and optionally removing any solicitation for services needed by the flow node once the services are filled-in and incorporated by the flow at step 57. The method 50 can then complete all the nodes of the flow, and create and deploy the service at step 58.

As noted above, exposing the flow of the service being built to other service providers, and allowing the service providers to fill-in the needed nodes in the flow can be accomplished by advertising WSDL files for the services needed by the flow nodes. Typically a WSDL file for a service describes what function the service can perform (the abstract interface), how to interact with the service (the binding), and where the service implementation is located (location). However, the WSDL files being advertised in accordance with embodiments herein represent what the flow (or service being created) needs in order for it to complete, and not what it currently can provide. Also, WSDL files can be published into a UDDI-like directory which again is used in a different way than a typical UDDI directory. A typical UDDI directory is used by service requestors (consumers) to find services they want to use. In contrast, a UDDI-like directory can be used here to advertise what is desired and to solicit the help of service providers to provide the services desired. Service providers have access to the directory and can provide the needed WSDL back to the framework. If the framework accepts the WSDL from the service provider, it will incorporate the WSDL in the flow under construction, and remove the advertisement from the directory. When all nodes of the flow are completed, the framework creates the service and deploys it.

Note, the UDDI (Universal Description, Discovery, and Integration) Project is an effort to define a set of specifications that will make it easier for businesses to accelerate the use of B2B and commerce over the Internet. UDDI does this by defining how companies can expose their business applications, like ecommerce, order management, inventory, marketing, and billing as Web Services that can be directly and securely defined, discovered and integrated with business applications at trading partners and customers.

The UDDI Project is based on existing Internet standards, is platform and implementation neutral, and has generated considerable momentum since its launch. Most importantly, UDDI involves the shared implementation of a Web Service based on the UDDI specifications. This Web Service, the UDDI Business Registry, is an Internet directory of businesses and the applications they have exposed as Web Services for trading partners and customers to use. Business programs will use the UDDI Business Registry to determine the specifications for programs at other companies in a manner similar to how people use Web search engines today to find websites. This automated application-to-application discovery and integration over the Internet will help eliminate many of the configuration and compatibility problems that are preventing businesses from more widely adopting B2B, despite B2B's potential for cost savings and improved efficiency.

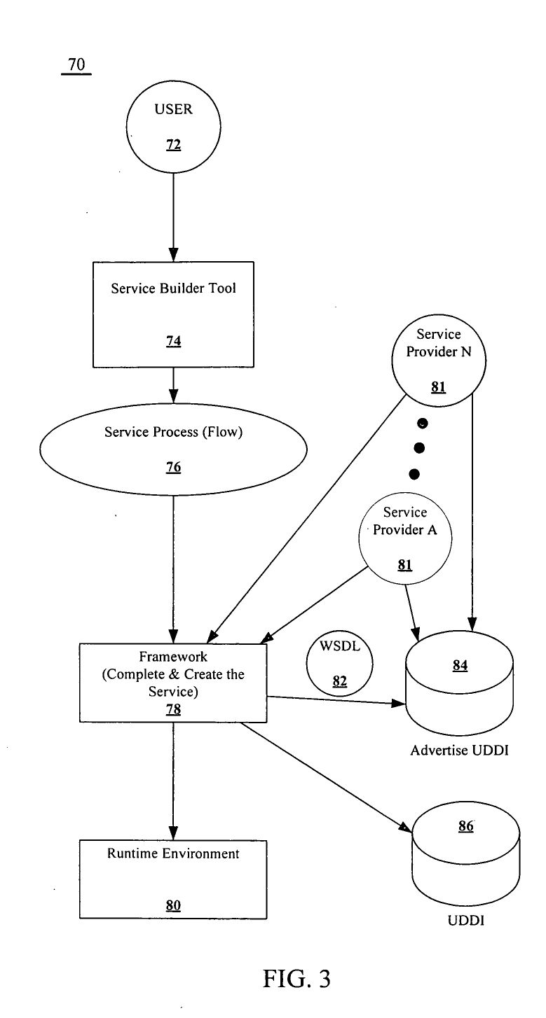

In summary and with reference to the method 70 illustrated in the flow chart of FIG. 3, a user 72 desiring to develop a service can use a service builder tool 74 to create a service process or flow 76. Each of the individual services is described by its own WSDL file, and is implemented by an endpoint application. Some of these endpoint applications might be provided by third party providers 81 (A through N), and might not be available at build-time. At build-time, the service interface (WSDL) is defined and without any particular binding to an endpoint. In accordance with an embodiment of the invention, a framework 78 enables the solicitation or advertising 84 of the individual WSDLs 82 as described above. The third party providers 81 can examine the WSDL 82 and determine if they can meet the specifications. Then, third party providers 81 can dynamically offer their WSDL (binding to their endpoint) during the runtime environment 80. Additionally, a traditional UDDI 86 can also be provided to offer services as is known, except that the services offered are created dynamically using the framework 78.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of dynamic creation of web services, comprising the steps of:
exposing a flow of a service being built to other service providers in a network;
soliciting for services needed by a flow node of the flow; and
enabling other service providers to fill-in the services needed for the flow node.

2. The method of claim 1, wherein the method further comprises the step of incorporating the services filled-in by the other service providers that were needed by the flow node.

3. The method claim 2, wherein the method further comprises the step removing any solicitation for services needed by the flow node once the services are filled-in and incorporated by the flow.

4. The method of claim 2, wherein the method further comprises the step of completing all nodes of the flow, creating the service and deploying the service.

5. The method of claim 1, wherein the step of soliciting comprises the step of advertising Web Service Definition Language (WSDL) files for the services needed by the flow node of the flow.

6. The method of claim 5, wherein the WSDL file represents at least one desired service that the flow needs in order to complete the service.

7. The method of claim 6, wherein the step of soliciting comprises the step of publishing needed WSDL files in a Universal Description, Discovery, and Integration (UDDI)-like directory.

8. A system for dynamically creating a web service using a network of service providers, comprising:
a processor coupled to the network of service providers, wherein the processor is programmed to:
expose a flow of a service being built to other service providers in the network;
solicit for services needed by a flow node of the flow; and
enable other service providers to fill-in the services needed for the flow node.

9. The system of claim 8, wherein the processor is further programmed to incorporate the services filled-in by the other service providers that were needed by the flow node.

10. The system claim 9, wherein the processor is further programmed to remove any solicitation for services needed by the flow node once the services are filled-in and incorporated by the flow.

11. The system of claim 9, wherein the processor is further programmed to complete all nodes of the flow, create the service and deploy the service.

12. The system of claim 8, wherein the processor is further programmed to solicit by advertising Web Service Definition Language (WSDL) files for the services needed by the flow node of the flow.

13. The system of claim 12, wherein the WSDL file represents at least one desired service that the flow needs in order to complete the service.

14. The system of claim 8, wherein the processor is further programmed to solicit by publishing needed WSDL files in a Universal Description, Discovery, and Integration (UDDI)-like directory.

15. A machine-readable storage, having stored thereon a computer program having a plurality of code sections executable by a machine for causing the machine to perform the steps of:
exposing a flow of a service being built to other service providers in a network;
soliciting for services needed by a flow node of the flow; and
enabling other service providers to fill-in the services needed for the flow node.

16. The machine-readable storage of claim 15, wherein the machine-readable storage is further programmed to incorporate the services filled-in by the other service providers that were needed by the flow node.

17. The method claim 16, wherein the machine-readable storage is further programmed to remove any solicitation for services needed by the flow node once the services are filled-in and incorporated by the flow.

18. The method of claim 16, wherein the machine-readable storage is further programmed to complete all nodes of the flow, create the service and deploy the service.

19. The method of claim 15, wherein the machine-readable storage is further programmed to solicit by advertising WSDL files for the services needed by the flow node of the flow.

20. The method of claim 1, the machine-readable storage is further programmed to solicit by publishing needed WSDL files in a Universal Description, Discovery, and Integration (UDDI)-like directory.
